(19) United States
(12) Patent Application Publication
(10) Pub. No.: US 2012/0045172 A1
(43) Pub. Date: Feb. 23, 2012

(54) GRATING COUPLER AND PACKAGE STRUCTURE INCORPORATING THE SAME

(75) Inventors: JUN-BO FENG, Beijing (CN); QUN-QING LI, Beijing (CN); SHOU-SHAN FAN, Beijing (CN)

(73) Assignees: HON HAI PRECISION INDUSTRY CO., LTD., Tu-Cheng (TW); TSINGHUA UNIVERSITY, Beijing (CN)

(21) Appl. No.: 12/979,314

(22) Filed: Dec. 27, 2010

(30) Foreign Application Priority Data
Aug. 23, 2010 (CN) 201010260139.1

(51) Int. Cl. G02B 6/34

(52) U.S. Cl. 385/37

(57) ABSTRACT

A method for removing phosphorus and nitrogen from an activated sludge wastewater treatment system is provided consisting of one or more anaerobic zones followed by two or more activated sludge reactors operating in parallel each having independent aeration/mixing means, whereby the utilization of the influent organic carbon under anoxic conditions, and thereby, the selection of denitrifying phosphate accumulating organisms (DNPAOs) over non-denitrifying phosphate accumulating organisms (PAOs), is maximized in order to further maximize the removal of phosphorus and nitrogen in the wastewater treatment system.

### RELATED APPLICATIONS

This application claims all benefits accruing under 35 U.S.C. §119 from China Patent Application No. 201010260139.1, filed on Aug. 23, 2010 in the China Intellectual Property Office, the disclosure of which is incorporated herein by reference.

### BACKGROUND

1. Technical Field

The present disclosure relates to a grating coupler and a package structure incorporating the grating coupler.

2. Description of Related Art

Grating couplers can include an isolation layer, a waveguide layer, a reflector layer, and an under-cladding layer, disposed on a substrate in turns. The reflector layer is disposed between the under-cladding layer and the waveguide layer. The isolation layer defines a hole for receiving an optical fiber. Optical signals through the optical fiber transmit through the isolation layer, and are captured by the grating coupler, and then optically coupled into an integrated optical chip. However, because the reflector layer is disposed between the under-cladding layer and the waveguide layer, the fabrication technology of the grating coupler is not compatible with conventional CMOS (Complementary Metal Oxide Semiconductor) technology and has a high cost, which makes mass production prohibitive.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a grating coupler.

FIG. 2 is an enlarged view of a substrate of the grating coupler of FIG. 1.

FIG. 3 is a schematic view of another embodiment of a grating coupler.

FIG. 4 is an enlarged view of a substrate of the grating coupler of FIG. 3.

FIG. 5 shows a bottom view of the substrate of FIG. 4.

FIG. 6 shows a side view of the substrate of FIG. 4 with an addition of a fixing element.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

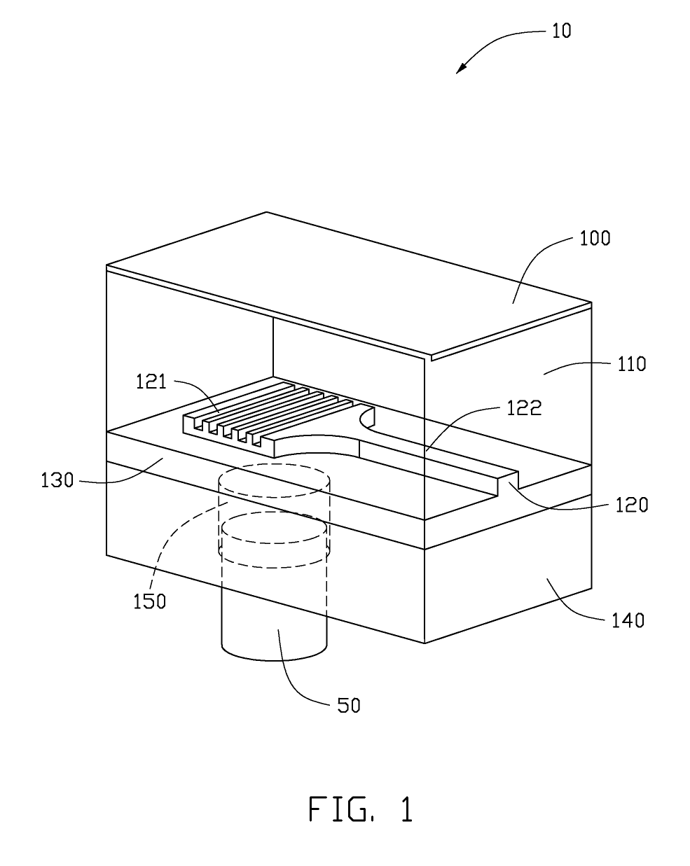

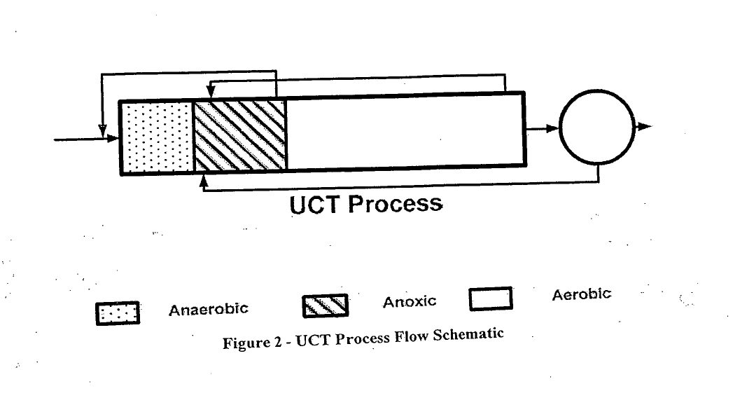

Referring to FIG. 1 and FIG. 2, one embodiment of a grating coupler 10 includes a reflector layer 100, an isolation layer 110, a waveguide layer 120, an under-cladding layer 130, and a substrate 140. The substrate 140 has a first surface 141, an opposite second surface 142, and a third surface 143 extending between the first surface 141 and the second surface 142. The under-cladding layer 130 is disposed on the first surface 141. The reflector layer 100, the isolation layer 110, the waveguide layer 120, and the under-cladding layer 130 are stacked on each other in sequence along a direction from the first surface 141 to the second surface 142. The reflector layer 100 is disposed on a surface of the isolation layer 110 and is away from the first surface 141 of the substrate 140.

The waveguide layer 120 can be made of silicon, and have a thickness in a range of about 200 nanometers to about 300 nanometers. The refractive index of the waveguide layer 120 is greater than the refractive index of the isolation layer 110 and the refractive index of the under-cladding layer 130. The waveguide layer 120 is disposed on a surface of the under-cladding layer 130, and the under-cladding layer 130 is sandwiched between the waveguide layer 120 and the substrate 140. The waveguide layer 120 is embedded in the isolation layer 110.

The waveguide layer 120 includes a ridge waveguide 122 and a grating 121 connected to the ridge waveguide 122. The grating 121 includes a plurality of substantially parallel grooves with a rib between every two adjacent grooves. The grooves are defined in one surface of the grating 121 away from the under-cladding layer 130. In one embodiment, the grating 121 has a width of about 20 microns and a length of about 20 microns. The grooves have a depth in a range of about 70 nanometers to about 100 nanometers. The grating period of the grating 121, that is, a sum of a width of one groove and a width of an adjacent rib, is in a range of about 300 nanometers to about 600 nanometers.

The isolation layer 110 can be made of silicon dioxide or silicon nitride. The isolation layer 110 has a thickness in a range of about 0.5 microns to about 5 microns.

The reflector layer 100 can be made from one of gold, silver, copper, and aluminum. The reflector layer 100 can have a thickness in a range of about 50 nanometers to about 200 nanometers. The reflector layer 100 is disposed on a surface of the isolation layer 110 and is away from the under-cladding layer 130. The reflector layer 100 can be easily formed through metal evaporation at low cost.

The substrate 140 can be made of silicon and have a thickness in a range of about 300 nanometers to about 500 nanometers. The substrate 140 has a fiber aligned groove 150 defined therein. The fiber aligned groove 150 allows installation of an optical fiber 50 therein. The fiber aligned groove 150 is depressed from the second surface 142 towards the first surface 141. A cross section of the fiber aligned groove 150 along a surface substantially parallel to the second surface 142 can be substantially square, circular, or triangular. In one embodiment, cross sections of the fiber aligned groove 150 along surfaces substantially parallel to the second surface 142 have about the same shape and size. It should be noted that the shape and the size of the cross section of the fiber aligned groove 150 along a surface substantially parallel to the second surface 142 can be adjusted to match the shape and size of the optical fiber 50 installed in the fiber aligned groove 150.

The fiber aligned groove 150 includes an opening 151, an end surface 153, and a lateral surface 152. The opening 151 is defined in the second surface 142. The end surface 153 is opposite to the opening 151. The end surface 153 is away from the first surface 141. The lateral surface 152 extends along a periphery of the end surface 153 to the opening 151. The fiber aligned groove 150 can be fabricated through wet etching or dry deep etching. The fiber aligned groove 150 can be aligned with the grating 121 through double sided lithography, so that a geometric center of the grating 121 is located on an extended line of a center line or an axis of the fiber aligned groove 150. Further, a geometric center of the end surface 153 is also located on the extended line of the center line or the axis of the fiber aligned groove 150. If the optical fiber 50 is installed in the fiber aligned groove 150, the optical fiber 50 will automatically be aligned with the grating 121.

The under-cladding layer 130 can be made of silicon dioxide and have a thickness in a range of about 2 microns to about 5 microns.

Moreover, the grating coupler 10 can include a plurality of overlapping gratings 121. The gratings 121 are connected to the same ridge waveguide 122.

In assembling the grating coupler 10 and the optical fiber 50, the optical fiber 50 is inserted into the fiber aligned groove 150 through the opening 151, and is then encapsulated or packaged therein. As a result, a grating coupler package structure is formed. In one embodiment, the optical fiber 50 can be encapsulated or packaged in the fiber aligned groove 150 using glue. In one embodiment, the optical fiber 50 has a flat end surface which is substantially perpendicular to an axis of the optical fiber 50. In one embodiment, the flat end surface of the optical fiber 50 can be in close contact with the end surface 153 of the fiber aligned groove 150.

In operation of the grating coupler package structure, the optical fiber 50 can be connected to an external photo-conducting device and receive optical signals from the external photo-conducting device. Optical signals from the optical fiber 50 can be optically coupled into an integrated optical chip through the grating coupler 10.

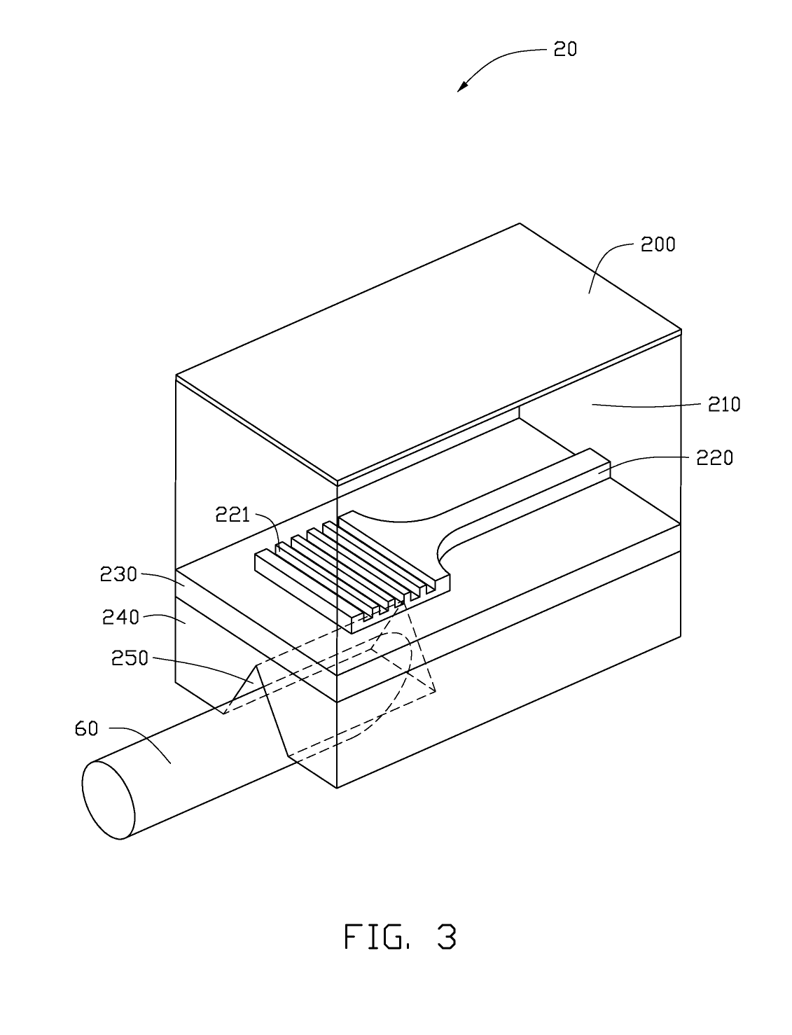

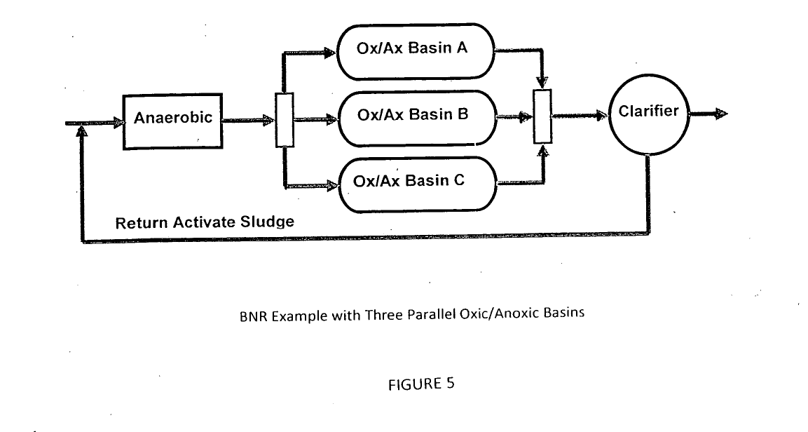

Referring to FIGS. 3-5, one embodiment of a grating coupler 20 is shown. The grating coupler 20 is similar to the grating coupler 10, and also includes a reflector layer 200, an isolation layer 210, a waveguide layer 220, an under-cladding layer 230, and a substrate 240. The main difference between the grating coupler 20 and the grating coupler 10 is that, the substrate 240 is different from the substrate 140.

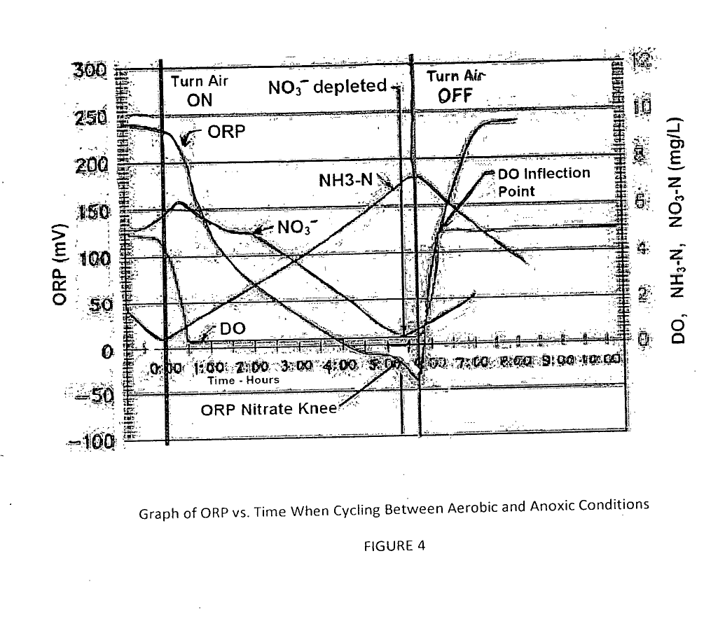

The substrate 240 includes a first surface 241, an opposite second surface 242, a third surface 243, and a fourth surface 244. The third surface 243 and the fourth surface 244 are located at opposite sides of the substrate 240. The third surface 243 and the fourth surface 244 extend between the first surface 241 and the second surface 242. When the substrate 240 is positioned in the position shown in FIG. 4, the third surface 243 and the fourth surface 244 are two lateral surfaces of the substrate 240.

The substrate 240 includes a fiber aligned groove 250. The fiber aligned groove 250 includes a first opening 2520, a second opening 251, an end surface 253 and two lateral surfaces 252. The first opening 2520 is defined in the second surface 242, and the second opening 251 is defined in the third surface 243. The first opening 2520 and the second opening 251 intersect with each other at a joint of the second surface 242 and the third surface 243. The end surface 253 is substantially parallel to and away from the fourth surface 244. The two lateral surfaces 252 extend from edges of the end surface 253 towards the first opening 2520, and the second opening 251, respectively.

The fiber aligned groove 250 is depressed from the second surface 242 towards the first surface 241, and is away from the first surface 241, as well as being depressed from the third surface 243 towards the fourth surface 244, and away from the third surface 243. A cross section of the fiber aligned groove 250 along a surface substantially parallel to the fourth surface 244 can be square, circular, or a triangular.

In one embodiment, cross sections of the fiber aligned groove 250 along surfaces substantially parallel to the fourth surface 244, are substantially triangular. The first opening 2520 is substantially rectangular. The second opening 251 is substantially triangular. The shape and the size of the cross section of the fiber aligned groove 250 along a surface substantially parallel to the fourth surface 244 can be adjusted to match the shape and size of an optical fiber 60 installed in the fiber aligned groove 250.

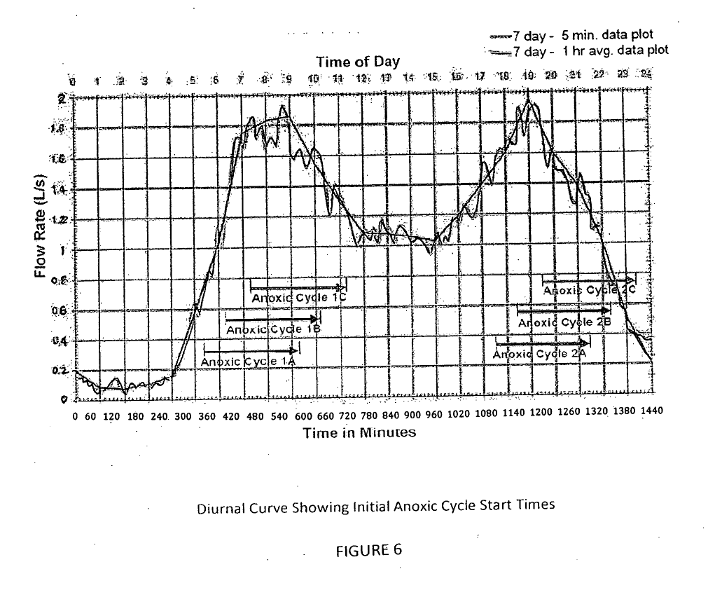

As shown in FIG. 6, the grating coupler 20 can further include a fixing element 300. The fixing element 300 can be a clip or an adhesive tape. In the embodiment shown in FIG. 6, the fixing element 300 can be a clip, which includes a protrusion 310 and two flanges 320 extending from opposite ends of the protrusion 310. The protrusion 310 protrudes up from the flanges 320 with a cavity defined below. The cavity corresponds to and matches with the fiber aligned groove 250 to receive the optical fiber 60 therebetween.

In assembling the grating coupler 20 and the optical fiber 60, the optical fiber 60 is inserted into the fiber aligned groove 250 through the first and second openings 2520, 251, and is then encapsulated or packaged therein. As a result, a grating coupler package structure is formed. In one embodiment, the optical fiber 60 can be encapsulated or packaged in the fiber aligned groove 250 by coating glue on the lateral surfaces 252.

In one embodiment, the optical fiber 60 has a flat end surface which defines an included angle of about 45 degrees with respect to an axis of the optical fiber 60. The optical fiber 60 is installed in the fiber aligned groove 250 with the flat end surface towards the second surface 242. The flat end surface defines an included angle of about 45 degrees with respect to the second surface 242. A line passing through a geometric center of the flat surface and a geometric center of the grating 221 is substantially perpendicular to the second surface 242.

In operation of the grating coupler package structure shown in FIG. 3, the optical fiber 60 can be connected to an external photo-conducting device and receive optical signals from the external photo-conducting device. Optical signals travel to the flat surface of the optical fiber 30, and are then reflected to the grating 221 by the flat surface of the optical fiber 60. The optical fiber 60 optically couples the optical signals into an integrated optical chip. During this process, some optical signals may transmit through the grating 221 and travel towards the reflector layer 200, and the reflector layer 200 can reflect back these optical signals and prevent signal leakage, so that the coupling efficiency of the grating coupler 200 can be enhanced.

As described above, the reflector layer 100/200 can be disposed on a surface of the isolation layer 110/210 and is away from the first surface 141/241 of the substrate 140/240, the reflector layer 100/200 can be easily formed through metal evaporation at low cost. Further, the fabrication technology of the grating coupler 100/200 can be compatible with conventional CMOS technology and has a low cost, which makes it possible for mass production. Further, because the fiber aligned groove 150/250 is defined in the second surface 142/242 of the substrate 140/240, it is convenient for aligning the optical fiber 50/60 with the grating 121/221.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What claimed is:

1. A grating coupler comprising:
a substrate having a first surface and an opposite second surface;
an under-cladding layer disposed on the first surface;
a waveguide layer;
an isolation layer; and
a reflector layer;
wherein the reflector layer, the isolation layer, the waveguide layer, and the under-cladding layer are stacked on each other in sequence along a direction from the first surface to the second surface.

2. The grating coupler of claim 1, wherein the reflector layer is made from one of gold, silver, copper, and aluminum.

3. The grating coupler of claim 1, wherein the reflector layer has a thickness in a range of about 50 nanometers to about 200 nanometers.

4. The grating coupler of claim 1, wherein the substrate further comprises a fiber aligned groove defined therein, the fiber aligned groove corresponding to the waveguide layer.

5. The grating coupler of claim 4, wherein the waveguide layer comprises a ridge waveguide and a grating connecting with the ridge waveguide, and the fiber aligned groove corresponds to the grating.

6. The grating coupler of claim 5, wherein the grating comprises a plurality of substantially parallel grooves with a rib between every two adjacent grooves; the grooves are defined in one surface of the grating and away from the under-cladding layer.

7. The grating coupler of claim 6, wherein the waveguide layer is buried in the isolation layer.

8. The grating coupler of claim 5, wherein the fiber aligned groove is depressed from the second surface towards the first surface.

9. The grating coupler of claim 8, wherein the fiber aligned groove comprises an opening, an end surface, and a lateral surface; the opening is defined in the second surface; the end surface is opposite to the opening; the end surface is away from the first surface; the lateral surface extend along a periphery of the end surface to the opening.

10. The grating coupler of claim 8, wherein a cross section of the fiber aligned groove along a surface substantially parallel to the second surface is a square, circle, or a triangle.

11. The grating coupler of claim 8, wherein a geometric centre of the grating is located on an extended line of a center line of the fiber aligned groove.

12. The grating coupler of claim 11, wherein a geometric centre of the end surface is located on the extended line of the center line of the fiber aligned groove.

13. The grating coupler of claim 5, wherein the substrate further comprises a third surface and an opposite fourth surface, the third surface and the fourth surface extend between the first surface and the second surface; the fiber aligned groove is depressed from the third surface towards the fourth surface.

14. The grating coupler of claim 13, wherein the fiber aligned groove comprises a first opening, a second opening, an end surface and two lateral surfaces; the first opening is defined in the second surface, and the second opening is defined in the third surface; the first opening and the second opening intersect with each other at a joint of the second surface and the third surface; the end surface is substantially parallel to and away from the fourth surface; the two lateral surfaces extend from edges of the end surface towards the first opening and the second opening, respectively.

15. The grating coupler of claim 14, wherein a cross section of the fiber aligned groove along a surface substantially parallel to the fourth surface is a square, circle, or a triangle.

16. A grating coupler package structure comprising:
an optical fiber; and
a grating coupler comprising:
a substrate having a first surface, an opposite second surface, and a fiber aligned groove;
an under-cladding layer disposed on the first surface;
a waveguide layer;
an isolation layer; and
a reflector layer;
wherein the reflector layer, the isolation layer, the waveguide layer, and the under-cladding layer are stacked on each other in sequence along a direction from the first surface to the second surface;
wherein the optical fiber is installed in the fiber aligned groove.

17. The grating coupler package structure of claim 16, wherein the optical fiber has an axis substantially perpendicular to the second surface.

18. The grating coupler package structure of claim 16, further comprising a fixing element, wherein the fixing element comprises a protrusion and two flanges extending from opposite ends of the protrusion; the flanges are mounted on the second surface; the protrusion protrudes upwards from the flanges with a cavity defined below; the optical fiber is installed between the cavity and the fiber aligned groove.

19. The grating coupler package structure of claim 16, wherein the optical fiber has an axis substantially parallel to the second surface, and the optical fiber has a flat end surface which defines an included angle of about 45 degrees with respect to the axis of the optical fiber.

20. The grating coupler package structure of claim 19, wherein the waveguide layer comprises a ridge waveguide and a grating connecting with the ridge waveguide; a line passing through a geometric centre of the flat surface of the optical fiber and a geometric centre of the grating is substantially perpendicular to the second surface.
